(19) United States
(12) Patent Application Publication
(10) Pub. No.: US 2023/0169594 A1
(43) Pub. Date: Jun. 1, 2023

(54) ALTERNATIVE ASSET BASED FINANCIAL MANAGEMENT CONTRACTS

(71) Applicant: FORWARD CONTRACTS, INC., Seattle, WA (US)

(72) Inventor: MICHAEL CHAPIRO, SEATTLE, WA (US)

(21) Appl. No.: 18/071,626

(22) Filed: Nov. 30, 2022

Related U.S. Application Data
(60) Provisional application No. 63/284,142, filed on Nov. 30, 2021.

(51) Int. Cl. G06Q 40/06; G06Q 40/12; G06Q 20/06

(52) U.S. Cl. CPC G06Q 40/06; G06Q 40/125; G06Q 20/065

(57) ABSTRACT

Systems and methods for a financial management system are described. The present disclosure describes systems and methods for finance management and financial investing. Embodiments of the disclosure include executing financial transactions between an employer and employee using a fiat currency and a cryptocurrency. In some cases, the financial management system purchases cryptocurrency with a portion of the employee salary and settles a contract based on a distributed ledger. Further, the financial management system transfers the difference between the settling amount and the fiat currency to the employee. The financial management systems and techniques described in the present disclosure may generally drive (e.g., incentivize, facilitate, enable, etc.) fiat currency toward cryptocurrency (e.g., as fiat currency is otherwise vulnerable without association with, or transfer to, a hard asset).

This application claims the benefit of U.S. Provisional Application No. 63/284,142, filed Nov. 30, 2021, for METHODS TO EFFECTIVELY DENOMINATE CONTRACTS IN ALTERNATIVE ASSETS WITH AUTOMATED FORWARD CONTRACTS, which is incorporated in its entirety herein by reference.

### BACKGROUND OF THE INVENTION

### 1. Field of the Invention

The present invention relates generally to finance systems, and more specifically to financial management of alternative assets.

### 2. Discussion of the Related Art

Various systems and processes are known in the art for managing finances.

In some aspects, human life originated as a result of the 2nd law of thermodynamics, whereby life is capable of generating negative entropy (e.g., ‘negentropy’) in the presence of an external power source (e.g., the Sun). For instance, life may be (or may include) a stochastic process where each agent perturbs the system and observes the result, providing for the discovery of more efficient negentropic processes to ensure. From this observation, each agent may over time generate some unique information that the agents are incentivized to not disclose publicly. In some cases, the agents may fail to increase (e.g., maximize) the negentropy within a local scope.

However, total absence of dissemination also leads to another minimum in the agent's negentropy capture. Therefore, the agent tactically discloses the information acquired through the stochastic process of perturbation and observation, often embodied indirectly and observable through the provision of goods and services. In some cases, the goods and services may be exchanged for other goods and services from agents that possess different information, such that the sum of negentropy producible between the two agents may increase. As a result of the energy increase, the reaction or “trade” is likely to eventually occur.

Due to the geometric growth of possible such reactions among even a handful of agents, which possess different pieces of (e.g., non-independent) information, a fraction of favorable reactions may actualize. Inefficiencies may arise due to the computation cost of evaluating whether the reaction is favorable. In some aspects, the computation is an intractable problem, and is therefore carried out stochastically. Since the computational complexity may grow with the number of comparisons to be made, a reduction in the scope (e.g., that can be certain to not be costly) may be energetically favorable. Such a scope reduction mechanism may be leveraged based on considering the space of reactions including a time element rather than reactions being determined a priori and occurring in a single instance.

Moreover, the aspect of time may include the consideration of sequences of information (e.g., one of which is the most energetically favorable), but where the particular sequence is extremely intractable. Therefore, in any such system, a type of meta-information arises that assists in the coordination of these sequences by providing for the computation to be split into two parts so that quasi-temporally-static computations can take place. Instead of speculating on stochastic paths, an agent can reduce their problem to strictly increasing negentropy potential with the existence of a “peg” that anchors to the total negentropy capacity across all agents.

A peg provides for an agent to make energetically favorable reactions occur with a facile greedy optimization algorithm that seeks to increase or maximize the negentropy potential of each individual reaction without making a large number of costly comparisons. Even without more sophisticated strategies where an agent might take an apparently less locally favorable reaction in order to achieve a superior global outcome, such an emergent multi-agent system may grow its total negentropy potential over time rather quickly. However, since the original mechanism discussed of perturbation followed by observation is costly and by definition cannot be directly cheated, any agent or group of agents that discovers a system to bypass this work process is guaranteed to execute upon it until such a flaw is patched up due to its globally, energetically unfavorable effects. The absence of such a patch will cause the eventual cessation of all activity among agents through the repeated exposure to the possibility of annihilation due to the constrains inherent from a measure in the otherwise continual and perceptually rapid increase in total negentropy.

An error at a local scope by an individual agent may not be considered a true error (e.g., since decisions of agents are themselves exploratory perturbations, whose outcomes are generally computationally intractable). In some examples, the relative energetic value of an action, regardless of the absolute value are intractable. Therefore, systemic flaws can occur with the peg, and any deviation from a perfect peg to the negentropy may be unfavorable, and thus may be highly unstable. In some cases, a plurality of agents that are established contain information not possessed by most or all of the other agents. The peg provides for diffusion of information with minimal latency. In some cases, distortion of the peg affects a destruction of information (i.e., meta-information the agent possesses with respect to the relation of the base information to the peg, which results in higher order information that follows being partially, and irreversibly destroyed) held by the agents since the peg contains no information. According to some examples, Landaeur's principle (i.e., 4th law of thermodynamics) states that destruction of information leads to an increase in entropy and a reduction in negentropy. Landaeur's principle follows from the destruction of information that prevents useful (i.e., negentropic) work from taking place among the agents with access to information.

In some aspects, money may be defined to include or refer to a peg that achieves the minimum information loss, such that the existence and utilization of money by the agents is the negentropy-maximal solution, which increases (e.g., maximizes) perceived well-being and subjective value for agents since subjective value is an illusory phenomenon by which the stochastic perturbations that seek out information that yields efficient negentropy generation systems are carried out. However, there have been many objects and numerical systems which people have referred to as money, which do approximate money, but none of them are money. Accordingly, there is a single unique solution to money. Since the pseudo-monies that are generated by fiat will be inherently corrupted to locally increase negentropy, fiat currency is not useful. For example, fiat currencies refer to money that is issued and backed by a government such as U.S. dollars issued and backed by the U.S. government.

Self-referential pegs are information-destructive since a perfect peg must be immune to variation amidst the internal set of information contained by the agents, which is, a peg must index across everything so no peg to a subset of “assets” works as money. Moreover, money may be unique since any multi-money system results in the demand (e.g., the requirement) to compute the relative position of the two monies, which leads to additional work being performed for each increase in negentropy.

One example solution to money was implemented a bit over a decade ago with the release of bitcoin, which has a supply cap (e.g., the key feature to enable a peg to the function properly) and a costly proof-of-work function with a difficulty adjustment (e.g., which solves the Byzantine General's problem, enabling lossless information transfer among agents, save for the cost of the proof-of-work, which utilizes the minimum energy necessary to prevent defectors from being able to affect the informatic-destructive, locally negentropic, globally entropic ways).

### SUMMARY

The present disclosure describes systems and methods for finance management and financial investing. Embodiments of the disclosure include executing financial transactions between an employer and employee using a fiat currency and a cryptocurrency. In some cases, the financial management system purchases cryptocurrency with a portion of the employee salary and settles a contract based on a distributed ledger. Further, the financial management system transfers the difference between the settling amount and the fiat currency to the employee. The financial management systems and techniques described in the present disclosure may generally drive (e.g., incentivize, facilitate, enable, etc.) fiat currency toward cryptocurrency (e.g., as fiat currency is otherwise vulnerable without association with, or transfer to, a hard asset).

A method, apparatus, non-transitory computer readable medium, and system for managing finances (e.g., finances including fiat currency and alternative assets) are described. One or more aspects of the method, apparatus, non-transitory computer readable medium, and system include executing a first financial transaction over a network facilitating an employer paying a portion of a salary to an employee in a fiat currency having an original fiat currency value; executing a second financial transaction comprising a loan of the portion of the salary to the financial management system for a predetermined period of time; purchasing a cryptocurrency forward contract with the portion of the salary with an expiration date equal to the predetermined period of time, wherein the purchasing includes recording the cryptocurrency forward contract on a distributed ledger associated with the cryptocurrency forward contract; settling the forward contract at the end of the predetermined period of time, wherein the settling includes recording the settling on the distributed ledger; comparing the settling amount to the original fiat currency value upon the settling of the forward contract; and transferring, from the financial management system to the employee, the difference between the settling amount and the original fiat currency value, wherein the difference is transferred upon determining that the settling amount is greater than the original fiat currency value.

### BRIEF DESCRIPTION OF THE DRAWINGS

FIG. 1 shows an example method of trustless execution of a bitcoin-denominated security deposit, according to aspects of the present disclosure.

FIG. 2 shows an example of a method for using a financial management system for employee investing, according to aspects of the present disclosure.

FIG. 3 shows an example financial management system, according to aspects of the present disclosure.

FIG. 4 shows an example view (e.g., a user interface view of a financial management system), according to aspects of the present disclosure.

FIGS. 5 through 8 show examples of methods for financial management, according to aspects of the present disclosure.

FIG. 9 shows an example of a financial management system, according to aspects of the present disclosure.

FIG. 10 shows an example of a computing device (e.g., a financial management apparatus), according to aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The present disclosure describes systems and methods for finance management. Embodiments of the disclosure include executing financial transactions between an employer and employee using a fiat currency and a cryptocurrency. In some cases, the financial management system purchases cryptocurrency with a portion of the employee salary and settles a contract based on a distributed ledger. Further, the financial management system transfers the difference between the settling amount and the fiat currency to the employee. Thus, the finance management, as described in the present disclosure, drives fiat currency toward cryptocurrency as fiat currency are vulnerable to being moved to a hard asset.

The mere existence of bitcoin guarantees an eventual total adoption (hyperbitcoinization, herein “day0”) and the collapse of pseudo-monies, which extends beyond fiat currencies that are currencies, but not money, and other stores-of-value through large monetary premiums on most assets.

The existence of multiple pseudo-monies and the time between the release of bitcoin and day0 results in some interesting arbitrage opportunities, which are disclosed herein. Within the arbitrage opportunities, a number of financial management systems/products/services are disclosed, along with some methods for their reduction to art.

The Cantillon Effect is an occurrence where there is a fiat monetary system (a “paper” money system that can be infinitely printed by a banking system), and select entities/individuals are able to appropriate the wealth of all other entities/individuals by receiving a large portion of new monetary units, and using the monetary units to acquire various hard assets, purchasing the assets at a price that does not take into account the inflated supply of the money.

Another aspect of the system is the avoidance of an explicit acknowledgement and the execution of elaborate rituals to reduce the odds that people understand. Thus, a majority of people at the top of the system may be oblivious to the effects of their own actions. This obliviousness, while providing a short-term stabilizing effect at a macro level, invariably results in arbitrage opportunities, along with many opportunities for speculative attack. Effectively, there is a massive energy potential difference driving fiat money (fiat currency) toward bitcoin, and there are various ways to tunnel through the activation energy needed to move the funds since fiat dollars are vulnerable to being moved to a harder asset until the fiat currency progresses to bitcoin. However, not all dollars are under the control of people that understand this and its value.

Therefore, wherever people who have observed this reality (colloquially, in the art, a “maxi”) are given the ability to move dollars into bitcoin, maxi people will perform the move. When people who are not “maxis” are given the opportunity to move dollars into bitcoin, non-maxi people will move the dollars into intermediary assets such as equities before observing reality.

Embodiments of the present disclosure may be used in the context of finance management applications. For example, a financial management system based on the present disclosure may include a execute financial transactions between an employee and an employer.

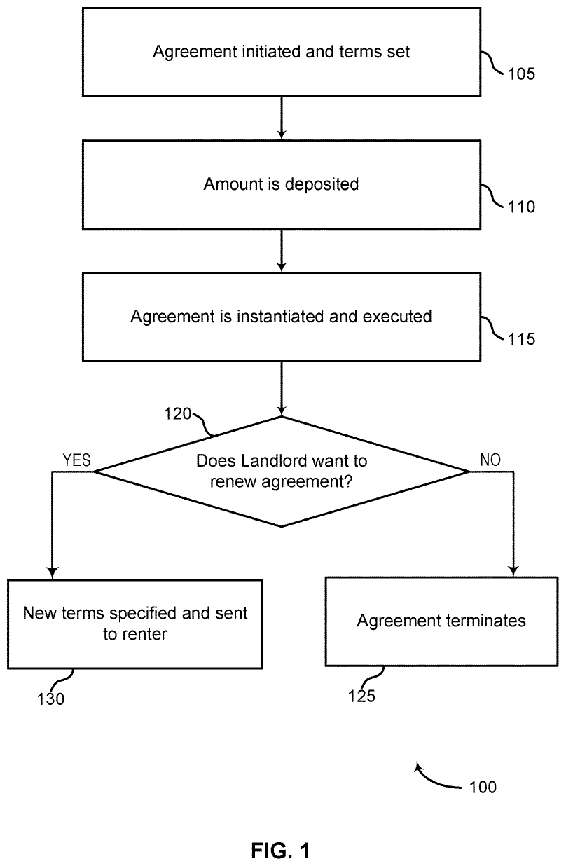

FIG. 1 shows an example of trustless execution of a bitcoin-denominated security deposit according to aspects of the present disclosure.

According to an embodiment of the disclosure, various rental or leasing agreements may include a request (or requirement) for the lessee/tenant to put up funds for a security deposit. The funds in the deposit are custodied by the landlord, but are considered the property of the tenant. In some jurisdictions, these funds are held in segregated accounts, sometimes with the use of an escrow holder. In some cases, the funds are held in an interest-bearing account.

The situations are costly to the maxi for the maxi person understands the forced short position on bitcoin. Accordingly, the maxi can get rid of the fiat currency at whatever market price is when the deposit is returned, which results in a substantial loss.

In some cases, the maxi has the deposit denominated in bitcoin to avoid the substantial loss. However, if the maxi gives bitcoin to the landlord, the landlord may steal the deposits of the maxi or tenant. Moreover, even in the case of an honest landlord, the increased fiat value of the bitcoin poses a risk to the tenant as the leasing contract intends a fiat-denominated deposit. Additionally, the fiat values are constrained by law as a multiple of the monthly rent. Further, since bitcoin is immutable, the landlord could lose the bitcoin in case of an error, become illiquid, and unable to purchase enough bitcoin to return the deposit to the tenant. A custodian could hold the funds in escrow which poses various risks that are known in the art.

Described herein is a service that enables the trustless execution of a bitcoin-denominated security deposit that resolves the concerns of parties.

A discreet-log contract (DLC) is a bitcoin-native mechanism of enabling smart contracts. A DLC or other methods (simpler solutions to reduce to art may exist) can be used to enable the smart contract. In a DLC, two parties lock up funds such that the funds are moved based on the observations of an “oracle”, which can be a piece of software that retrieves data from relatively trustworthy sources such as a large financial exchange where the price of an asset at some time can be observed.

The tenant can deposit bitcoin for a security deposit such that the deposit bitcoin cannot be retrieved by any party. After the lease ends (or upon mutual agreement of the tenant and landlord in case the lease ends prematurely), or some days after within which the deposit must be returned, the landlord specifies the amount of the deposit they intend to withhold for damages in US dollars (USD), not to exceed the total security deposit, as denominated in USD in the rental agreement. Thus, the amount of bitcoin corresponding to the withheld amount of USD in the deposit is sent to the landlord, or the landlord gives custody of their end of the contract to the contract facilitator, which sells the bitcoin and delivers fiat to the landlord since the majority of landlords are “NGMI” (i.e., not going to make it which is used to describe instances in the crypto world when one makes a bad decision) and prefer to interact with fiat.

In some cases, the amount of bitcoin sent for funds withheld is based on the price as retrieved by the Oracle. The Oracle can retrieve the price from several exchanges and computes the variation in prices to reduce the risk that one or more of the exchanges collapses for failing to return a price or returning a false price. The remaining bitcoin is sent back to the tenant such that if the price of bitcoin is higher than when the deposit is made, the tenant is assured to receive the funds without being exposed to the possibility of theft. In the case when there are no damages, the entire bitcoin deposit is returned directly to the tenant.

Given the volatility of bitcoin, the landlord may trust a service such that the initial deposit in bitcoin is a multiple of the fiat amount (i.e., the excess multiple is not part of the legally withholdable portion of funds in fiat-denominated terms, but in bitcoin-denominated terms may become withholdable at the end of the lease if the price of bitcoin has fallen). Alternatively, or additionally, the tenant can be requested or required to deposit additional bitcoin funds if the price falls, and can be a mechanism to provide for withdrawal of excess bitcoin if the deposit is over-secured by an amount above the initial multiple for an amount of time. In some cases, the deposit may be rolled over if the lease is renewed.

The service of facilitating the smart contracts can be provided with a fee that is added to the initial bitcoin deposit. A service could be provided where the landlord is able to view the DLC, locked deposited funds, and control the funds, for example, a digital wallet with related features. Such a trustless lending system may be a software that the landlord controls, or be built into a custodial platform with a login system.

Embodiments of the present disclosure include a method that enables further trust minimization. For example, the Oracles could be built from short scripts in the bitcoin blockchain via transaction messages, which may be beneficial in preventing any tampering of the contract by the service provider of the contracts, enabling the counterparties to have even greater confidence in using the product.

In some examples, the contracts can be used in other cases and access to implementing the contracts within another app could be provided by the oracle that implements the contract via an API. The API may enable 3rd party software platforms to offer the contracts natively, e.g., all-in-one websites such as Apartments.com™, short term rental apps such as Airbnb®, short term auto-leasing, boat leasing, aircraft leasing, or any other application in which a security deposit is requested or required.

Additionally, similar systems could be enabled to support deposits being held in equities or a system can be built focused on a cryptocurrency with no value or purpose (e.g., meme tokens and scams) e.g., a “DeFi Dapp” with Ethereum®.

As an example, Alice deposits X amount of USD in bitcoin. At some fixed date in the future, 70% of X amount of USD is transferred to Bob as a bitcoin transaction (price is checked on a large exchange), and the remaining bitcoin (assuming numbers go up “NGU” or no more than 30% drop) is returned to Alice. Bob indicates his interest in receiving funds within a time window prior to the end date, and he can choose to receive any amount of funds between 0 and 70% of X. In some embodiments, a feature is included where if the bitcoin price is below some level for X amount of time, additional bitcoin must be deposited by Alice.

As another example, Bob can be a “nocoiner” (a person who doesn't invest in cryptocurrency), and would want to receive dollars. The financial management system can be the counterparty to Alice and sell the bitcoin to provide Bob with the bitcoin. Thus, the financial management system enables both parties to be able to set everything up with a very simple UI.

Accordingly, as shown in FIG. 1, in a first operation 105, the agreement is initiated and the terms set. The landlord enters or scans a deposit address (automatic if built into a digital wallet). The landlord also specifies the deposit amount and date for the deposit to be returned (e.g., X number of days after agreement) and that data is stored by the trustless lending system.

In a second operation 110, after the agreement, an amount is deposited. In some embodiments, the amount is up to 2× the deposit amount to endure sufficient funds amidst volatility. The trustless lending system generates a receive address for the location of the deposit.

In a third operation 115, the agreement is instantiated and executed. The landlord sends the receive address to the renter. The renter enters the receive address in an application of the trustless lending system (e.g., a web browser application) to confirm that the receive address is part of a valid contract. The renter then sends the amount to the receive address. A portion of the amount is taken by the system as payment for use of the system (in some examples 1% of the amount)

In a fourth operation 120, the landlord decides to renew the agreement or not. If the landlord does nothing (e.g., at operation 125), the DLC executes to cause the time-locked transaction to RBF back to the renter. If the landlord wishes to retain a portion or all of the deposit, the landlord inputs to the trustless lending system the amount of the deposit they want to retain. The DLC then pulls the price from the exchange APIs, then executes a transaction that sends funds to landlord's digital wallet, with the balance sent back to the renter.

In the case where the landlord wants to renew the agreement (e.g., at operation 130), new terms are specified, and the new terms are sent to and approved by the renter. The DLC them moves the 2× deposit into a new DLC (retaining the percent (e.g., 1%) for payment of system) and returns balance to renter.

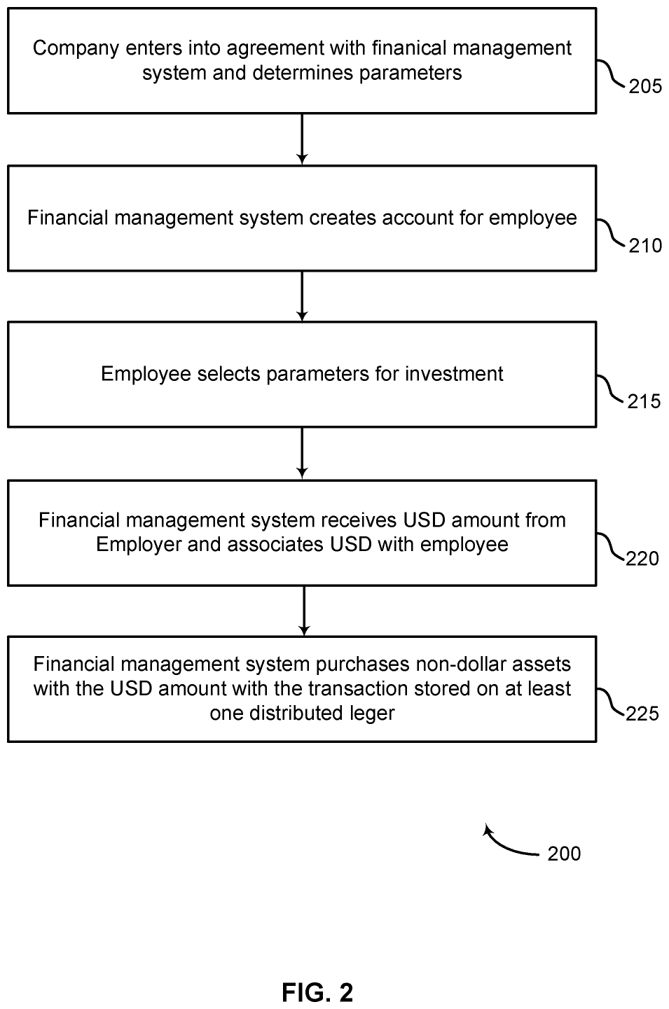

FIG. 2 shows an example of a method 200 for using a financial management system for employee investing according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Given the widespread use of fiat currency, multiple corporations have with large amounts of fiat on their balance sheets, and fiat is the primary currency they use to conduct business. The dollar or other fiat currencies are the unit of account and the unit in which contracts are typically denominated, including contracts for employing people. Since corporations know they have contractual obligations to pay employees dollars, they often hold large quantities of these dollars. Though the corporations know that such a step is making the dollars lose value over time, the corporations are unable to hold harder assets since the non-ergodic nature of holding less than the entire sum of goods and services leads to an absorbing barrier via volatility, which would result in corporations being unable to meet financial obligations.

A system is disclosed herein for financial management that enables the shift into assets that are not guaranteed to lose value while mitigating the existential risk. Accordingly, the system modifies employment contracts to become partially denominated in alternative assets from fiat. Since the alternative assets may be high in fiat value as fiat accelerates towards zero, as fiat currencies are known to do, the system assists the corporation in purchasing the assets needed to pay the employers ahead of time, providing for market neutrality. In some cases, dollars are held due to the employee expecting dollars. Additionally, or alternatively, other assets are held since the employee is expecting the other assets.

The concept of alternative assets can be reduced to art in a financial software product for implementation. Funds from a bank can automatically be moved and traded in an exchange with an API. Other implementations could include direct purchase of bitcoin for which the system would provide custodial services, which would be particularly beneficial in implementing the valuable feature of employee protection by having the system seize returns above a threshold to solve the game theory of the financial arrangement that would require a smart contract that an employer may be unwilling to provide.

The system caps upside to limit employee gains in the event of firing the employee. For example, if the amount held by the employee makes 300% gains and the employee is fired, the system would retain the gains above some threshold (e.g., 30%). The flow is beneficial for payroll processing and implications of the frequent salary changes to be handled within the payroll app, avoiding complexity in regulatory/tax compliance.

FIG. 2 shows an example of a method for financial management according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In a first operation 205, a company enters into an agreement with the financial management system, including definition of terms of the financial agreement (e.g., amount paid to the financial management system, types of assets available, time frame when an employee is “vested”, limits on amount of profit an employee can withdraw, etc.). The amount of payment of the company to the financial management system is determined. In one embodiment, a percentage of the lowered USD payroll amount is paid to the financial management system. For example, if the employer pays 98% of payroll in USD, a percentage (e.g., 45%, 40%, or 35%) of the remaining 2% would go to the financial management system. In one embodiment, a greater advance payment (e.g., 2 years instead of 1 year) may result in the percentage being lowered (e.g., from 45% to 40%).

In a second operation 210, an employee creates an account with the financial management system.

In a third operation 215, the employee selects the parameters for the investment. In one parameter, the employee chooses a proportion of their salary to be directed to assets as opposed to being received in dollars as usual. With the baseline being 100% of their salary received in dollars, a first example option for investment is receiving 98% of their salary in dollars over the course of the year and investing 15% of their salary in the assets. In another example, the employee receives 94.75% of their salary plus 35% invested in the assets. The investment period is a fixed period of time, for example 1 year. The employee can select a single asset or multiple assets.

In a fourth operation 220, after selection of parameters, an amount of dollars corresponding to a multiplier of the percentage of assets (e.g., stocks, cryptocurrency) is transferred to the financial management system and the financial management system buys the assets and associates them with the employee. The multiplier takes into account taxes and other costs of the employer. The total advance payments are retained by the financial management company since upon leaving, the financial management company can return the advance payment to the company.

In a fifth operation 225, the financial management system interacts with at least one distributed ledger to purchase non-dollar (e.g., cryptocurrency) assets with the amount of dollars.

According to an embodiment of the present disclosure, the amount an employee is shown for the salary is less than what gets invested since the total cost of the employee moves with the price of the asset for the corporation to remain market neutral. In some cases, the multiplier grows slightly with high salaries, is not constant across employees, and is not constant for each employee. In some embodiments, the differences in multipliers as a salary grows may not be considered within an employee. In some versions, the multiplier is given an additional multiplier based on expected shifts in the multiplier given certain expectations as to asset growth rate.

In an example of operation with the employee selecting 35% of the salary in assets for a 1-year time period, 35% of 1 year of salary is accessible for the employee to allocate into assets. For example, 1 year has N number of pay periods (e.g., every 2 weeks), so the company has stocks through period N. Accordingly, before period 1 completes, the company sells 1/Nth of the portfolio and adjusts the employee's salary to salary+(35%×portfolio gains). At the end of the 1st pay period, the company purchases additional stock (e.g., 35% of salary divided by N) for the (N+1)th pay period, so the amount held is less than the amount that was sold if portfolio is growing for 1 year. Additionally, the value of the portfolio to each pay period is not uniform. In some examples, the portfolio doubles in value during the first pay period. Next, in the (N+1)th pay period, getting an allocation proportional to a constant USD amount, is worth half the preceding pay periods. As a result, each pay period can have a percentage of the overall portfolio.

In another example, the employee selects as assets 50% bitcoin and 50% Apple® stock. Defining the time period as 50 weeks, and at the onset 1 bitcoin=1 Apple share. For example, 1 bitcoin and 1 Apple® share are bought each week. In some examples, bitcoin increases in value by 10 times. As a result, 0.1 bitcoin+1 Apple® share are appended on the tail end of subportfolios. The tail end subportfolios are 50% bitcoin and 50% Apple® stock by value, but the initial ones are roughly 90% bitcoin and 10% Apple®. Thus, the employee may change new subportfolio construction or change the subportfolios to some new value to reconcile the variation.

In another embodiment, the financial management system considers the total monetization of a new asset that can lead to the collapse of other currencies and the total elimination of monetary premium in hard assets used as pseudo-monies. For example, the requirement of volatility can be observed based on a pre-fiat0 (hyperbitcoinzation) with little volatility. Accordingly, an asset is obtained that has grown ˜200% year over year since inception, with no perceived risk. The existence of volatility can lead to the belief that this is not inherently bounded such that there is an absorbing barrier at zero (0). However, this would ignore that the singularity of “infinity” is also an absorbing barrier from which there is no return.

For example, models such as stock-to-flow (i.e., S2F) show a basic mathematical illiteracy. The price of bitcoin is tautologically the number of dollars coming in divided by the percentage of weak hands that will sell bitcoin. In some cases, a finite time singularity, which can occur with the weak hands falling to 0 (i.e., before hyperinflation of the fiat currency) or the fiat currency hyperinflates driving the nominal price to infinity even as weak hands remain. Regardless, the finite time singularity is mathematically defined as a hyperbolic growth curve, which is faster than any exponential growth curve as the singularity is approached.

Knowing that fiat0 is inevitable, the price growth of bitcoin is hyperbolic, and that most people are oblivious to inevitability of fiat0 and growth of bitcoin, a product can be provided that reduces price volatility while still providing exposure to bitcoin. A “stable bitcoin” fund/asset is provided that can be purchased instead of bitcoin that hedges against volatility. This enables hedging within the bitcoin asset itself rather than having to limit total exposure to bitcoin. This enables much higher exposure to bitcoin in a portfolio that may have thresholds (e.g., or requirements) related to volatility. Various strategies for hedging are known in the art and it has been proposed to delta hedge and purchase protective puts for bitcoin. However, these approaches have failed to consider hyperbolic growth and hyperbitcoinization's inevitability, which limits bitcoin utility.

The hyperbolic growth means that a portfolio with a combination of long exposure (whether direct or with futures) that hedges with enough protective puts to reduce volatility sufficiently will substantially underperform bitcoin. Though this may be acceptable since such underperformance of bitcoin will exceed the performance of just about everything else. However, it is possible to recuperate part of these losses from put options that will be inherently overbid by people that expect total collapse of bitcoin through the purchase of call options to capture upside. The existence of a bitcoin ETF (exchange-traded fund) enables the use of hedging strategies with options on the ETF rather than bitcoin itself, allowing for trading in a market that will have deeper liquidity.

Any number of algorithms could be implemented with these considerations. Such algorithms could be fully automated and provided as a private fund or a public equity.

As an example, 70% of bitcoin are held long and 30% are allocated to options each year in USD-denominated terms, with 25% used to purchase short term protective puts, and 5% to purchase short term call options. In some aspects (e.g., given bitcoin's 150-200% compound annual growth rate (CAGR)), even higher levels of costly hedging may result in expected returns that vastly exceed any other market.

Reduced volatility enables people to allocate more capital when they anticipate they may need to spend it within some short timeframe, which is commonly desired for large managed funds, as well as among the poorest people in society that may live paycheck to paycheck. This helps both of them.

It would be possible to offer as a fund, or as a personalized fund that is uniquely generated for each customer such that they specify a number of parameters that matter to them e.g., the extent of volatility reduction they choose or need—perhaps 30% drops are ok for them, but 80% drops are problematic. Moreover, such a system could modify its hedging strategies based on beliefs of the customer: e.g., the customer could specify the year in which they expect hyperbitcoinization to occur, as well as whether they understand that bitcoin will absorb all monetary premiums or if they want models that imagine bitcoin will only reach a $10-100 trillion market cap.

Additionally, it is contemplated that a financial product for more bullish investors that don't mind volatility could also be produced with a combination of long spot and call options, which can offer the benefits of long leverage upside without the existential liquidation risk.

Another factor of these sorts of managed stable bitcoin financial products is that they can be incorporated into the previously described systems of the company financial asset management system and trustless execution of a bitcoin-denominated security deposit.

For security deposits, a hesitant person can instead purchase this managed asset. For the company financial asset system, it is particularly beneficial in reducing the risk premium cost that the employer would have to charge their employees, enabling greater utilization. This greater utilization could enable higher percentages of the salary that can be allocated to alternative assets. Sufficient risk reduction would eventually enable as high as total allocation.

This can be thought of a method of diversifying across the various paths to hyperbitcoinization. A plurality of paths can be entertained such that the hedging portion of the portfolio can allocate a highly leveraged position to each path such that whichever path materializes generates enough of a return to smooth volatility.

Contractual obligations between companies that are denominated in fiat have a carrying cost and the provision of goods/services in which inventory is carried may incentivize or require companies to have a short position on bitcoin. As hyperinflation accelerates, this will lead to companies being unwilling to purchase goods over holding bitcoin. Such a situation could lead to a total collapse of supply chains in foundational industries where margins are low enough—the lower the margin, the shorter a holding period that can be tolerated. Instead of prepaying, contracts could require the purchaser to denominate in bitcoin even if they pay in dollars. This simplifies accounting and may alleviate PR concerns that “NGMI” fiat corporations care about. A quote for a product can be offered in bitcoin, followed by a purchase order in bitcoin. Upon the purchase order (PO) generation, that amount of bitcoin can be immediately purchased through an instruction generated in a software as a service (SaaS) product, and then N days after delivery, the bitcoin can be sold and an equivalent amount of USD is sent. Integrating these sorts of capabilities with exchanges, banking, and accounting services may be beneficial.

In another embodiment, the investment method includes forwardation. Previously, an approach was described where a company offers their employees the option to have part of their salary denominated in non-dollar assets (e.g., cryptocurrency), going out 1 year forward. There is a free salary tier (e.g., 5% of salary is denominated, with the employee being paid their entire salary in USD), and higher percentages of non-dollar denomination may result in, or require, the employee to take a pay cut to their base salary.

Each pay period, the corresponding sub-portfolio of non-dollar assets that that employee selected is sold, their salary is raised or lowered, and they are paid correspondingly. Additionally, another sub-portfolio of assets is purchased for the pay period that is, for example, 1 year out. In some aspects, these are trades of the corporations for its own purpose of achieving market neutrality rather than an integral part of the agreement the employer makes with its employees (e.g., a company may choose to be short the assets, but platforms described herein may not allow the company to be short).

In a further approach, the employee salary itself may never changes—instead, the agreement is roughly an actual forward (save for the embedded unilateral optionality for each party associated with quitting/firing), where immediately after the employee is paid, they may purchase the underlying basket of non-dollar assets—so there is a transfer in both directions, but the employer will still settle with the financial management system into USD, and then add the two transactions together so only a single transaction is used or needed for settlement (which means funds move from employee to employer if the asset dropped in value). This transaction could in principle be combined with the salary payment, but can be simpler from an accounting and software perspective to have it separate.

The funds that would be locked up in the hedging portfolio in the previous embodiment are instead provided to the financial management system as a loan so that the financial management system can purchase the hedging portfolio and settle the contracts directly with the employees. This removes the company from being directly involved in the forward contract, and eliminates any capital gains/losses hitting their balance sheet. The result is that the product is simplified from the customer perspective, and the financial management system can capture dividends on the assets being held.

This eliminates challenges with payroll software integration, and unforeseen problems that might arise by changing salaries every pay period. It also eliminates the “gains” from being employment payments for which employment taxes would be owed. Finally, it may allow the gains to be long term capital gains instead of income after 1 year.

This approach offers a few advantages including {but not limited to} the tax treatment for the employer is improved—whereas in the previous embodiment, gains are offset by salary expenses, losses with lower salary expenses means they can only offset the loss to a gain, which they might not have (along with other applicable rules about carrying forward/backward). Additionally, tax treatment for the employee is improved: instead of being income at whatever bracket they are in, 60% of futures are long term capital gains—given that this is for employees, the majority would have 0% federal taxation on this since they'd likely be below ˜$40 k tax bracket, which makes their forward option roughly 25% more valuable, thus allowing the price of the premium to be higher.

Accordingly, the financial management system, as described in the present disclosure, does not adversely affect payroll. There may be errors introduced in the attempt to affect a salary change every single pay period and push that change via an API to a payroll software that deals with all the backend compliance issues. In some industries, salaries may be set in stone sometimes years in advance and you certainly would not be allowed to change the salary every 2 weeks. This approach would obviate that issue. In some cases, since actual salaries fluctuate, overhead/tax costs also fluctuate so keeping the employer market neutral means it may be appropriate to insert a multiplier where additional assets are purchased. This introduces the problem that that multiplier is sometimes non-linear, and may even experience jumps, so the market neutrality cannot be perfectly maintained, which likely is a cost to the employer—moreover, case 1 locks up that additional capital, which decreases the value to the employer for a given premium.

The system previously described had lesser advantage for employees paid close to minimum wage since a loss in their forward assets could cause their actual salary to drop below minimum wage. If an employee is already at the minimum wage, the employee cannot take a pay cut to pay the premium for the forward. Instead, the forward agreement has the price set below the spot price (backwardation). This not only allows the employee investing application to be feasible for any income level, it also provides a way to break minimum wage laws via backwarded forward pricing.

For taxation purposes, there may be advantages (depending on the regulations in place at the time) for the system including a series of cash-settled bullet (unregulated) swaps, with one forward contract per pay period, it could increase the eligibility for sold assets to be categorized as long-term capital gains instead of short-term capital gains.

Operating directly with cryptocurrency enables the easy and rapid final settlement of the asset through the API, whereas using a security system to transfer assets (such as DTCC's ACAT system) is costly, slow, and often cannot be automated via an API.

For the company/employer/corporation, regardless of whether the sum total of portfolios across employees is up or down in any year, there is always a gain and loss that offset each other since the company will always be hedged with perfect neutrality, so the employer benefits from not having taxable events. Moreover, these contracts may not be marked-to-market. Finally, whenever bitcoin is held that dips in value, losses can be captured since bitcoin has no cash-sale rule.

The forward contract embodiment is a tool that makes it easy to implement an over-the-counter (OTC) forward market between any two parties to create “composite moneys”, looking specifically at the function of money as a standard for deferred payment such that any contract stipulates value to be exchanged in any basket of tradeable assets, rather than defaulting to denominating contracts in dollars. This can be applied to any supply chain where agreements are negotiated for production that is ongoing for some amount of time, any situation in which funds are locked up to be transferred at a future date, or any product that stipulates recurring payment.

In one embodiment, pseudo-monetary components can be created within the “composite money”, wherein the pseudo-monetary components are made out of one or more stabilized versions of individual assets, i.e., instead of just an asset, an actively traded algorithm on a particular asset to shift certain financial parameters (e.g., bitcoin) with an option/put strategy that hedges downside volatility at the expense of capturing the full upside. In another embodiment, the provision of heavily collateralized bitcoin-backed bonds where a person can simply select as their monetary standard the bitcoin bonds, and be confident that they will return something like 30% yearly, and if it is 5× collateralized, it would only fail with something like an 80% draw-down).

In one example, an employee gets paid $10 k/month salary. The current price of bitcoin is around $58 k. So, with the financial asset management system, they could transform their salary to $9.4 k/month+a forward to purchase 0.05 bitcoin (btc) for $2.9 k every month when they are paid ($9.4 k/month present value} for the following 13 months (cash or cash+btc settlement).

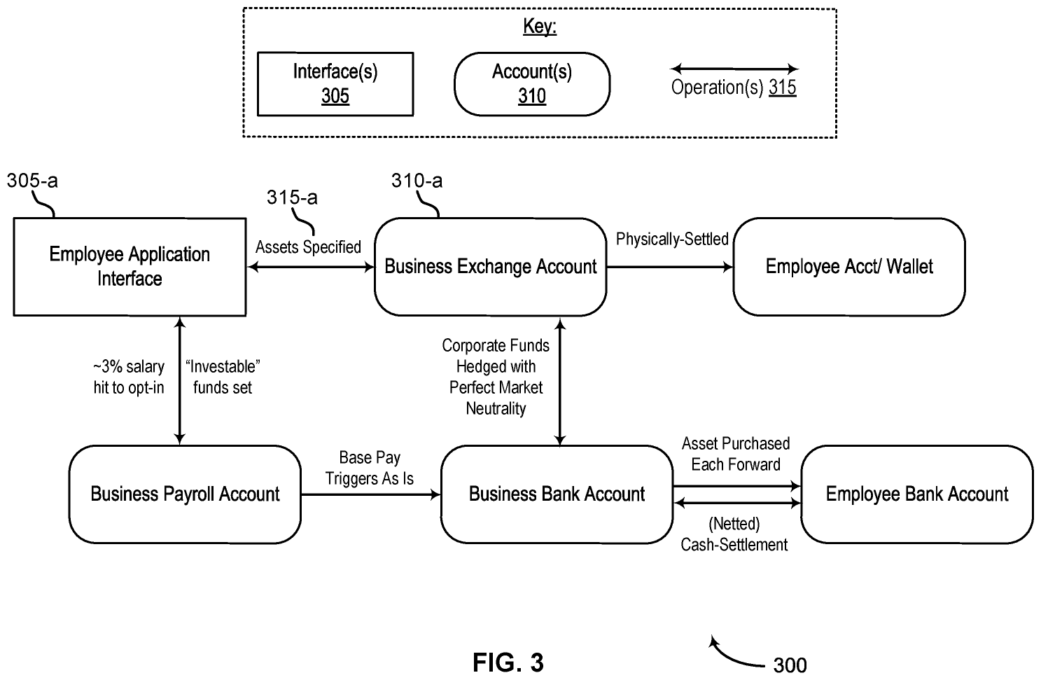

FIG. 3 shows an example financial management system 300 according to aspects of the present disclosure. For instance, in some aspects, financial management system 300 may include, at least, one or more interfaces 305, one or more accounts 310, and one or more operations 315. In the example of FIG. 3, financial management system 300 may include an interface 305 (e.g., such as employee application interface 305-a), accounts 310 (e.g., such as a business exchange account 310-a, a business payroll account 310, a business bank account 310, an employee account or employee wallet 310, and an employee bank account 310), and operations 315 (e.g., such as asset specification operations 315-a, opt-in operations 315, settlement operations 315, hedging operations 315, etc.).

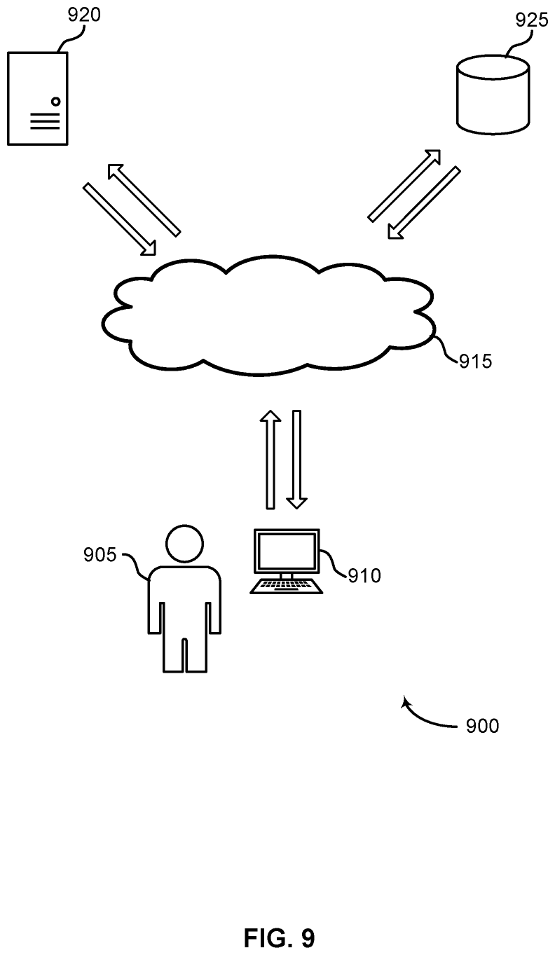

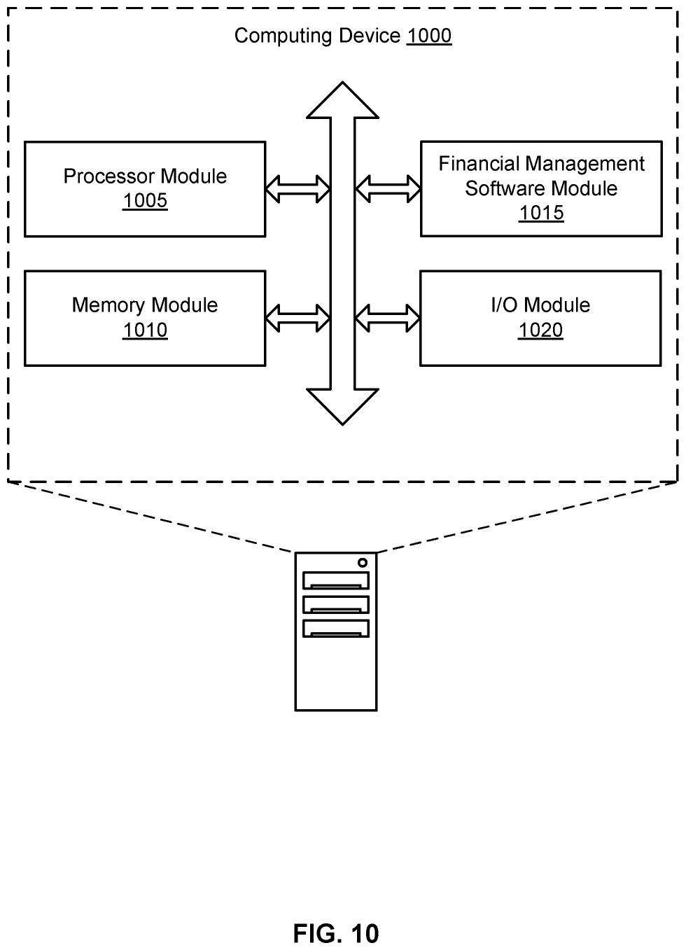

In some cases, financial management system 300 may implement any aspects of the methods described elsewhere in FIGS. 1, 2, and 5-8. In some cases, financial management system 300 may be an example of, or include aspects of, a financial management system and/or a computing device described in more detail herein (e.g., with reference to FIGS. 9 and 10).

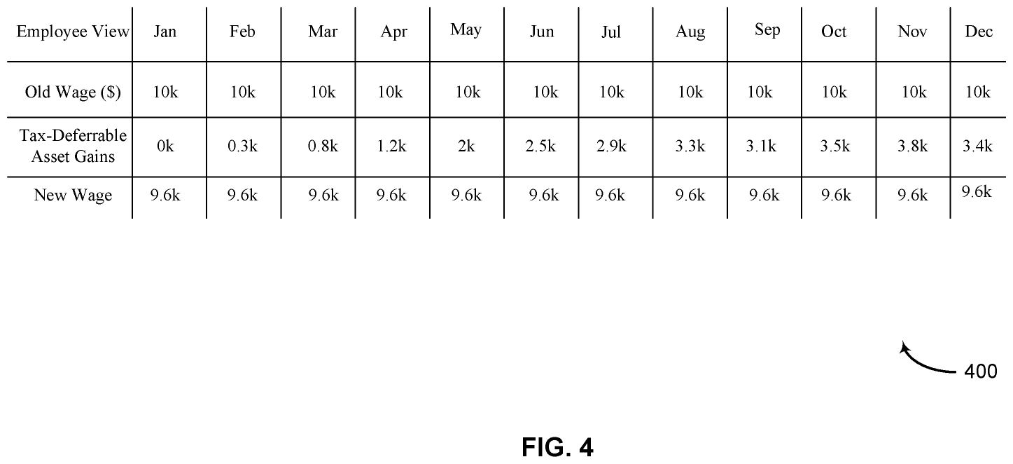

FIG. 4 shows a view 400 according to aspects of the present disclosure. In some aspects, view 400 may be an example of a finance comparison log, an employee view of a user interface of a financial management system, etc.

For instance, in aspects of the example shown in FIG. 4, the employer may have a $10 million balance sheet, and $5 million yearly payroll expenses. The employer allocates $1.5 million to market neutral portfolio. $500 k capital gain−$500 k capital loss=0 net gain/loss for the employer. The USD original salary (“old wage”) is shown in USD (10 k/month). The “new wage” per month is 9.6 k, where the remaining $400 is used for the forward contract. The tax-deferrable asset gains are shown for each month.

Though the employee is agreeing to take a pay cut and this is a sort of consideration, it is not a direct premium payment for the forward contract since future wages are not funds that the employee actually owns, so perhaps it might not be considered payment of a premium, and this means that the forward is being underpriced, as the forward should always have a premium (contango) when the money is inflationary.

In some cases, the forward were further underpriced, for example, the salary reduced to $2 k/month (near minimum wage}, along with a forward to purchase 0.15 btc for $2 k each month. This forward represents $8.7 k in btc for a cost of $2 k, which >12 months out would then have $6.7 k in long term capital gains, or if physical settlement does not trigger a taxable event, 0 gains/income other than the $2 k base income. This would allow both employee and employer to massively reduce their tax burden.

Prices could be enabled at the ordinary rates for lower income persons who might otherwise not be able to utilize the financial management system due to the possibility that their wage could drop below minimum wage even if they perceive the expected value of the forwards is positive. So consider a person making $2 k/month to start. The company wants to pay someone $1 k/month. They keep their salary of $2 k/month and add a forward whereby they may purchase 0.01 btc (present value-$580) for $1600 each month (so the cost to the employer is $980/month when they hedge).

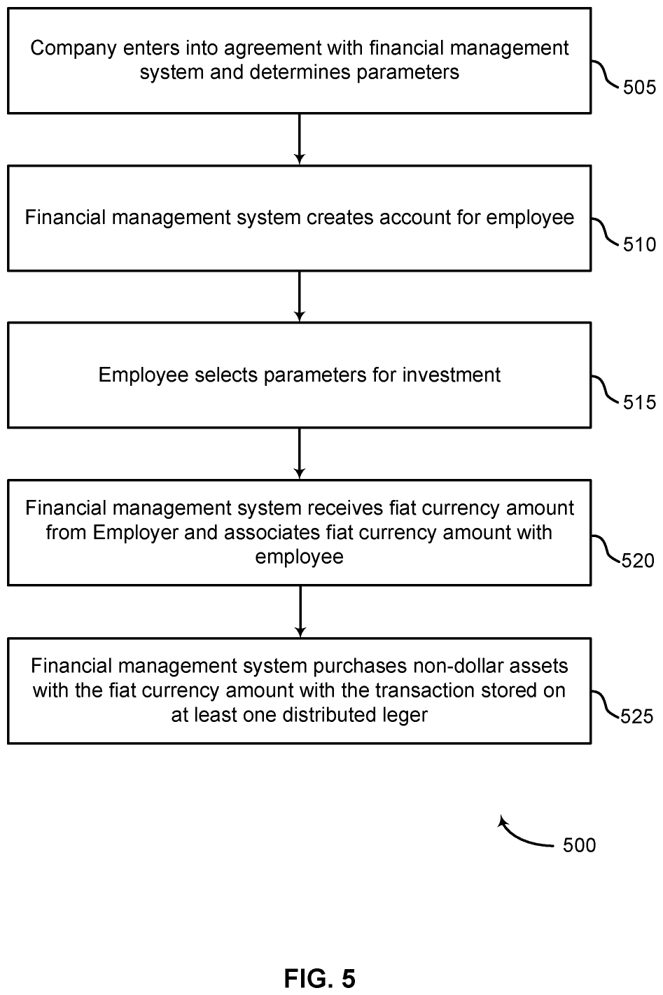

FIG. 5 shows an example of a process for a forwardation method according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In a first operation 505, the company enters into agreement with financial management system and determines parameters.

In a second operation 510, financial management system creates account for employee.

In a third operation 515, employee selects parameters for investment.

In a fourth operation 520, financial management system receives fiat currency amount from employer and associates fiat currency with employee.

In a fifth operation 525, financial management system purchases non-dollar assets with the fiat currency amount with the transaction stored on at least one distributed leger.

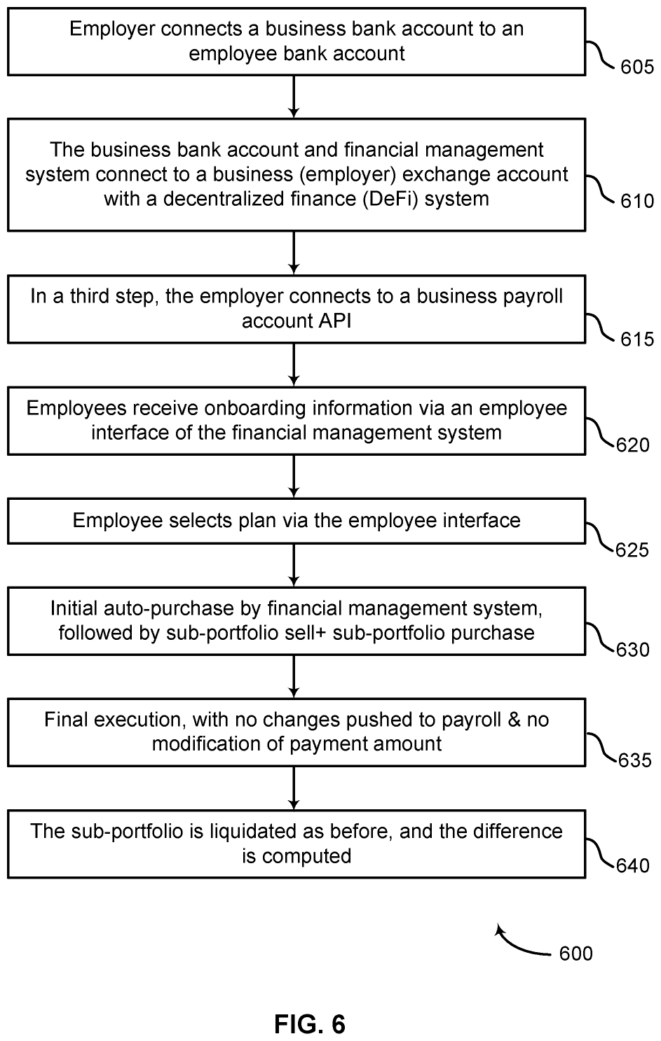

FIG. 6 shows an example of a forwardation method according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In a first operation 605, the employer connects a business bank account to an employee bank account that will be used to fund exchange account via Teller™. Because payments may be able to flow in both directions, the employee as part of the registration process may also go through a bank connection process.

In a second operation 610, the business bank account and financial management system connect to a business (employer) exchange account with a decentralized finance (DeFi) system such as Alpaca™. In some embodiment the DeFi system includes a credit-based mechanism.

In a third operation 615, the employer connects to a business payroll account API, which is used to change employee salary. In some embodiments this is a Universal API such as Finch™.

In a fourth operation 620, employee receives onboarding information via an employee interface of the financial management system.

In a fifth operation 625, employee selects plan via the employee interface.

In a sixth operation 630, initial auto-purchase by financial management system, followed by sub-portfolio sell+sub-portfolio purchase, where the base amount to purchase is based solely on the employee's salary with no multipliers.

The next operation, i.e., 635 is final execution, with no changes pushed to payroll & no modification of payment amount. The new salary with the pay cut remains constant outside of the employee changing the plan they are on.

In an operation 640, the sub-portfolio is liquidated as before, and the difference is computed. Now, in the case that the portfolio goes down, a transfer payment from the employee to the employer is made. Otherwise, a payment from the employee to the employer is made.

If someone is hired on a platform such as TopTal™ or UpWork™, they may very well want access to the financial management system. Importantly, since contractors are often hired through these centralized platforms, partnering with one of them is a way to instantly achieve significant scale.

Instead of the time period being a year, the time period could be based on a number of hours. This could be cryptocurrency (e.g., bitcoin) only from the start (instead of some salary in USD or other fiat currency).

Employer could pay to offer the OTC contracts to contractors. Assets sold. Employee is paid. Then that payment is paid to company for that amount plus difference. The gain and loss are perfectly offset. The contractor salary constant other than drop. An employer using the tool with a single contractor has less incentive to cheat them if price rips since the individual contractor cost is small compared to the company's operating budget. Employer allocates funds and locks them into a vault with option of paying contractor. If funds are not paid to contractor after a certain amount of time, excess funds are sent to the financial management system, and rest returned to employer. Physically-settling the actual asset with forward may be particularly beneficial for contractors since short term contracts would otherwise lead to short term capital gains.

A contractor can be a company rather than an individual, such as a business-to-business (B2B) interaction. So it could be a company purchasing services of any variety with the larger entity having low-interest funds to market make. People prepay for SaaS because it's cheap, but it's no different from prepaying for labor and getting a discount, but people don't want to prepay before a labor service has been received.

Companies can also set up supply purchases in stock/btc denominated prices. In one example, a company supplies carbon fiber and has certain output. They want to guarantee they can sell it for a certain value. They agree to sell to a large, well-known company “B” X amount of goods every month at a USD price, but that will cause issues for them because their suppliers won't set a USD price, so they ask “B” to guarantee payments in alternative (non-dollar) assets, so they can pay their sub-tier suppliers. “B” will do it because “B” doesn't want supply chain hiccups, which means they will charge less than an employer—plus, vendors are illiquid. However, a machine shop selling parts can have more flexibility than a carbon fiber supplier. The financial management system platform could be extended as a software solution where any entities can setup their own custom forward contracts via GUI or API rather than having to negotiate through lawyers and complex documentation. This enables agreements to be executed with the efficiency and flexibility of software, which is beneficial since it enables the stability of a transition through a hyperinflationary regime, with various benefits such hundreds of millions of people being able to not starve to death, and so on. Various embodiments are possible when considering the financial management system platform as applied to any sort of recurring business transaction where employment is merely a single instance of a type of good/service that is provided commercially on a recurring basis, and it can be shown to be analogous to various other aspects of commercial trade/supply chains, or sales agreements.

For any embodiment of the financial management system that is cash settled, it could be connected to a tool that enables the employee to automatically rebuy the asset in proportion to what they had in the financial management system employee interface application, with the option to scale the distribution of non-dollar assets to all the dollars being received as t>1ell.

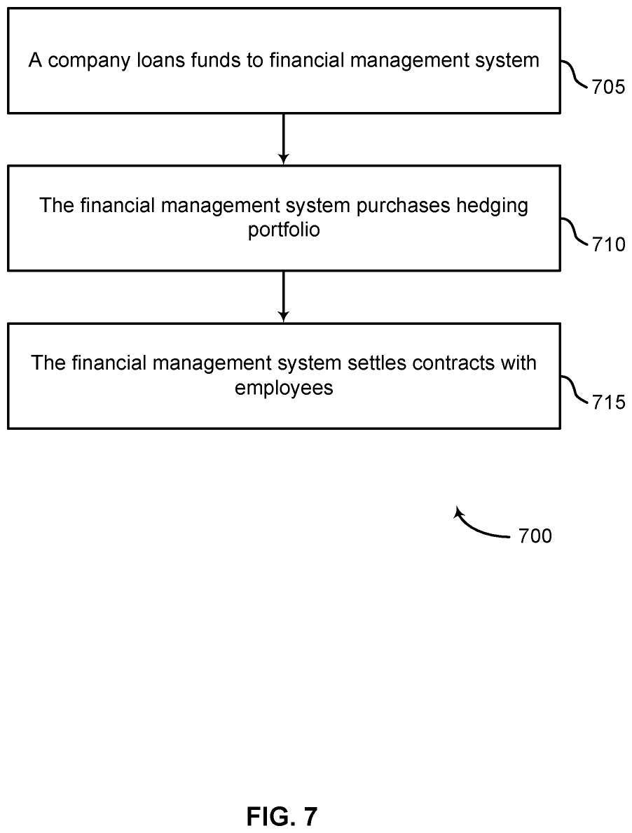

FIG. 7 shows an example of financial management system according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, the forward contracts (an informal agreement traded through a broker-dealer network to buy and sell specified assets, typically currency, at a specified price at a certain future date.) involved the company purchasing the hedging portfolio (automated by the financial management system), and settling the contracts with their employees. In another embodiment, the funds that would be locked up in the hedging portfolio are instead provided to the financial management system as a loan so that the financial management system purchases the hedging portfolio and settles the contracts with their employees. This removes the company from being directly involved in the forward contract, and eliminates any capital gains/losses hitting their balance sheet. The result is that the product is simplified from the customer perspective, and provides the advantage to the financial management system that it can capture dividends on the assets being held.

In a first operation 705, a company loans funds to financial management system.

In a second operation 710, the financial management system purchases hedging portfolio.

In a third operation 715, the financial management system settles contracts with employees.

A further embodiment uses a protocol that allows any asset to be connected to a cryptocurrency distributed ledger (e.g., bitcoin/blockchain), using de minimis quantities of the cryptocurrency to track ownership of some asset and serve to provide access to an account where those assets can be redeemed. In some embodiment the assets can be transferred over a second layer added to the distributed ledger that allows off-chain transactions (i.e., transactions between parties not on the distributed ledger). In one embodiment, in conjunction with blockchain a suitable protocol is Taro™, utilizing the Lightning Network™.

While the protocol can be used to move fiat money natively on a distributed ledger, equities can also be utilized. In one embodiment, “stablecoins” are created that are composed of a portfolio of assets, which could even be automatically rebalanced. In one example, a “stablecoin” is created named “Caliber Dollars”. Caliber dollars in one example consists of 70% USD 10% bitcoin (cryptocurrency), 10% Spywolf (cryptocurrency), and 10% XLE (exchange-traded fund).

Using the protocol in conjunction with the financial management system prevents the non-double credit problem, where a custodian can issue more claims than they have reserves. Using the protocol, the claim-set is publicly auditable in the same way cryptocurrency on a distributed ledger is. However, the reserves are still uncertain. By having a protocol-as-a-Service product (e.g., Taro), the financial management system can provide a brokerage that has a public API to an account's holdings so that they may be used in conjunction with the protocol. Moreover, the financial management system can introduce rules around redemption and issuance so that it is impossible for the protocol asset issuer to run off with the funds.

A “stablecoin” (caliber dollars in this example) can then be used as an alternative monetary unit in contracts, specifying future payments, without having to have very complex terms. It eliminates the need to have contracts change value due to inflation or consumer product index (CPI), for example in long duration leases, and it can embed hedging in instances such as the automotive industry that otherwise has to take a more complex approach. These Caliber Dollars or some variant could also be used as part of the financial management system since most people find it easier to think about a “coin” than a portfolio.

In another embodiment, a cryptocurrency distributed ledger is used to provide an intermediate option between an unsecured loan and an overcollateralized loan. A cryptocurrency “asset” describes a public/private key pair, where the public key derives addresses allowing a person to receive the cryptocurrency (e.g., bitcoin), and the private key allows them to sign transactions that spend the cryptocurrency. It is possible to configure what is called a multi-sig address i.e., cryptocurrency that requires multiple cryptographic signatures for the cryptocurrency to move. One of the most common multi-sig schemes is called 2-of-3, which is to say there are 3 private keys and any 2 of them are able to move the cryptocurrency. Companies have employed 2-of-3 multisig in lending arrangements where a loan for dollars is overcollateralized by bitcoin—the lending company holds 1 private key, the customer holds another private key, and a 3rd party holds the final private key. This scheme is purported to protect the customer, but it fails under a number of circumstances including when the 3rd party is actually under the total control of the lending company, or in the event of a government mandated wealth seizure. It is desirable that some greater assurance could be offered to the customer.

A 2-of-2 multisig is proposed, called “deadlocked” cryptocurrency as a solution that minimizes trust among parties wishing to conduct business. A 2-of-2 multisig with the lender holding 1 key and the borrower holding another key is cryptographically un-rehypothecatable. In the event of default, the collateral cannot be unilaterally seized by the lender, nor can the borrower run off with it. This provides an intermediate option between a totally unsecured loan, and an overcollateralized loan where the borrower is taking the risk of trusting a custodian (the custodian could lose the cryptocurrency via hacking as well, it need not be malicious). In particular, this deadlocked cryptocurrency is utilized for a product where the financial management system lends customers dollars to purchase cryptocurrency (e.g., bitcoin) on installment plan/layaway model. The customer locks in the immediate price, and pays off their loan over time while being confident their cryptocurrency cannot be seized, while the interest rates are able to be lower than if it were unsecured.

In another embodiment, the user interface of the financial management system includes a button that when selected executes a limit sell order, and as soon as the limit sell order fills, immediately executes a market buy order. This ensures the dollar holding period is a fraction of a second, and allows the first sell to be a limit, which minimizes fees. Some embodiments include a 0-click tax loss harvest, which executes the following: if the user has bitcoin that has fallen in value by X % (set by user), execute a tax loss harvest (which might include a DON'T EXECUTE if the drop happened “too quickly” to avoid the risk of selling a flash crash and rebuying at a much higher price even with an immediate buy order).

In another embodiment, the financial management system allows a user to specify some dollar number X. Whenever their bank account exceeds this balance, funds are moved into brokerage and market buy cryptocurrency. Whenever their account drops below this value, cryptocurrency is sold and the dollars moved to the user's bank account. Additionally, the financial management system can offer an external API to banks so that banks can allow transactions to go through even if there are zero dollars in the account: the API would offer banks a two-step process: 1) check if user has sufficient cryptocurrency to cover transaction, 2) lock funds within that customer's brokerage account, assuring that the funds cannot be moved somewhere else—this amounts to the bank providing a “flash loan” that costs them basically nothing. This method is a superior alternative to DCA (dollar cost average) where there is simply a fixed auto transfer and buy of cryptocurrency, which gets particularly ineffective for someone with lumpy income.

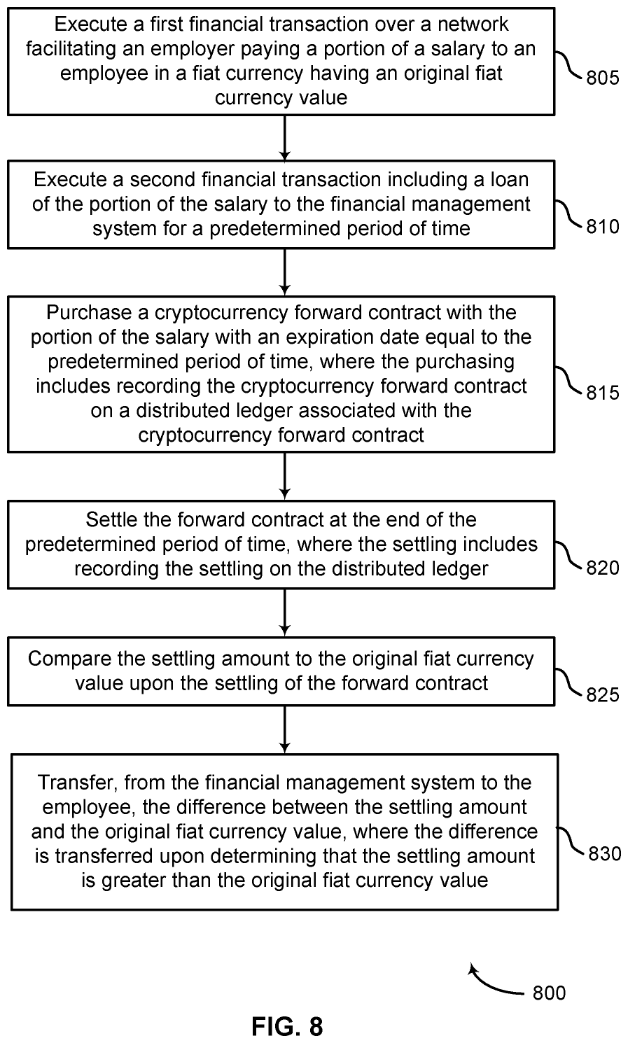

FIG. 8 shows an example of a method 800 for financial management according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system executes a first financial transaction over a network facilitating an employer paying a portion of a salary to an employee in a fiat currency having an original fiat currency value. In some cases, the operations of this step refer to, or may be performed by, a financial management software module as described with reference to FIG. 10.

At operation 810, the system executes a second financial transaction including a loan of the portion of the salary to the financial management system for a predetermined period of time. In some cases, the operations of this step refer to, or may be performed by, a financial management software module as described with reference to FIG. 10.

At operation 815, the system purchases a cryptocurrency forward contract with the portion of the salary with an expiration date equal to the predetermined period of time, where the purchasing includes recording the cryptocurrency forward contract on a distributed ledger associated with the cryptocurrency forward contract. In some cases, the operations of this step refer to, or may be performed by, a financial management software module as described with reference to FIG. 10.

At operation 820, the system settles the forward contract at the end of the predetermined period of time, where the settling includes recording the settling on the distributed ledger. In some cases, the operations of this step refer to, or may be performed by, a financial management software module as described with reference to FIG. 10.

At operation 825, the system compares the settling amount to the original fiat currency value upon the settling of the forward contract. In some cases, the operations of this step refer to, or may be performed by, a financial management software module as described with reference to FIG. 10.

At operation 830, the system transfers, from the financial management system to the employee, the difference between the settling amount and the original fiat currency value, where the difference is transferred upon determining that the settling amount is greater than the original fiat currency value. In some cases, the operations of this step refer to, or may be performed by, a financial management software module as described with reference to FIG. 10.

FIG. 9 shows an example of a financial management system 900 according to aspects of the present disclosure. In one aspect, financial management system 900 includes user 905, user device 910, cloud 915, computing device 920, and database 925. Computing device 920 is an example of, or includes aspects of, the corresponding element described with reference to FIG. 10.

The user device 910 may be a personal computer, laptop computer, mainframe computer, palmtop computer, personal assistant, mobile device, or any other suitable processing apparatus. In some examples, the user device 910 includes software that incorporates a financial management application (e.g., a financial investing system). The question answering application may either include or communicate with the event argument extraction apparatus.

In some examples, the user device 910 and the computing device 920 may be a same device (e.g., a single device). For instance, the computing device 1000 described with reference to FIG. 10 may be an example of the user device 910, the computing device 920, or both. In other examples, the computing device 1000 described with reference to FIG. 10 may be implemented in system 900 via both the user device 910 and the computing device 920, where operations may be performed on either the user device 910 and/or the computing device 920.

Cloud 915 is a computer network configured to provide on-demand availability of computer system resources, such as data storage and computing power. In some examples, the cloud 915 provides resources without active management by the user 905. The term cloud 915 is sometimes used to describe data centers available to many users 905 over the Internet. Some large cloud 915 networks have functions distributed over multiple locations from central servers. A server is designated an edge server if it has a direct or close connection to a user 905. In some cases, a cloud 915 is limited to a single organization. In other examples, the cloud 915 is available to many organizations. In one example, a cloud 915 includes a multi-layer communications network comprising multiple edge routers and core routers. In another example, a cloud 915 is based on a local collection of switches in a single physical location.

Computing device 920 includes a computer implemented network. Computing device 920 may also include a processor unit, a memory unit, an I/O module, and a training component. The training component is used to train a machine learning model (e.g., a diffusion model). Additionally, computing device 920 can communicate with database 925 via cloud 915. In some cases, the architecture of the image processing network is also referred to as a network or a network model. Further detail regarding the architecture of computing device 920 is provided with reference to FIG. 10. Further detail regarding the operation of computing device 920 is provided with reference to FIGS. 5-8.

In some cases, computing device 920 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Database 925 is an organized collection of data. For example, a database 925 stores data in a specified format known as a schema. A database 925 may be structured as a single database 925, a distributed database 925, multiple distributed databases 925, or an emergency backup database 925. In some cases, a database 925 controller may manage data storage and processing in a database 925. In some cases, a user 905 interacts with database 925 controller. In other cases, database 925 controller may operate automatically without user 905 interaction.

FIG. 10 shows an example of a financial management apparatus according to aspects of the present disclosure. The example shown includes computing device 1000, processor module 1005, memory module 1010, financial management software module 1015, and I/O module 1020. Computing device 1000 is an example of, or includes aspects of, the corresponding element described with reference to FIG. 9.

Processor module 1005 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Memory module 1010 includes instructions executable by processor module 1005. Examples of a memory module 1010 include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory module 1010 operates memory cells. For example, the memory module 1010 can include a row decoder, column decoder, or both. In some cases, memory cells within a memory store information in the form of a logical state.

I/O module 1020 may manage input and output signals for a device. I/O module 1020 may also manage peripherals not integrated into a device. In some cases, an I/O module 1020 may represent a physical connection or port to an external peripheral. In some cases, an I/O module 1020 may utilize an operating system such as iOS®, ANDROID®, MS-DOS®, MS-WINDOWS®, OS/2®, UNIX®, LINUX®, or another known operating system. In other cases, an I/O module 1020 may represent or interact with a modem, a keyboard, a mouse, a touchscreen, or a similar device. In some cases, an I/O module 1020 may be implemented as part of a processor. In some cases, a user may interact with a device via I/O module 1020 or via hardware components controlled by an I/O module 1020.

According to some aspects, financial management software module 1015 executes a first financial transaction over a network facilitating an employer paying a portion of a salary to an employee in a fiat currency having an original fiat currency value. In some examples, financial management software module 1015 executes a second financial transaction including a loan of the portion of the salary to the financial management system for a predetermined period of time. In some examples, financial management software module 1015 purchases a cryptocurrency forward contract with the portion of the salary with an expiration date equal to the predetermined period of time, where the purchasing includes recording the cryptocurrency forward contract on a distributed ledger associated with the cryptocurrency forward contract. In some examples, financial management software module 1015 settles the forward contract at the end of the predetermined period of time, where the settling includes recording the settling on the distributed ledger. In some examples, financial management software module 1015 compares the settling amount to the original fiat currency value upon the settling of the forward contract. In some examples, financial management software module 1015 transfers, from the financial management system to the employee, the difference between the settling amount and the original fiat currency value, where the difference is transferred upon determining that the settling amount is greater than the original fiat currency value.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for financial investing, comprising:
executing, by a financial management system configured for network communication and comprising at least one processor, a non-transitory memory, and at least one software module configured to run on the at least one processor, a first financial transaction over a network facilitating an employer paying a portion of a salary to an employee in a fiat currency having an original fiat currency value;
executing, by the financial management system, of a second financial transaction comprising a loan of the portion of the salary to the financial management system for a predetermined period of time;
purchasing, by the financial management system, of a cryptocurrency forward contract with the portion of the salary with an expiration date equal to the predetermined period of time, wherein the purchasing includes recording the cryptocurrency forward contract on a distributed ledger associated with the cryptocurrency forward contract;
at the end of the predetermined period of time, settling of the forward contract by the financial management system, wherein the settling includes recording the settling on the distributed ledger;
upon settling of the forward contract, comparing of the settling amount to the original fiat currency value; and
upon determining that the settling amount is greater than the original fiat currency value, transferring from the financial management system to the employee the difference between the settling amount and the original fiat currency value.

2. A financial management system, comprising:
at least one computing device comprising a processor and non-transitory memory and in communication with at least one distributed ledger through a network; and
at least one financial management software module configured to run on one of the at least one computing device, wherein the system is configured to:
execute a first financial transaction over a network facilitating an employer paying a portion of a salary to an employee in a fiat currency having an original fiat currency value;
execute a second financial transaction comprising a loan of the portion of the salary to the financial management system for a predetermined period of time;
purchase a cryptocurrency forward contract with the portion of the salary with an expiration date equal to the predetermined period of time, wherein the purchasing includes recording the cryptocurrency forward contract on a distributed ledger of the at least one distributed ledger, wherein the distributed ledger is associated with the cryptocurrency forward contract;
at the end of the predetermined period of time, settle the forward contract, wherein the settling includes recording the settling on the distributed ledger;
upon settling of the forward contract, comparing of the settling amount to the original fiat currency value; and
upon determining that the settling amount is greater than the original fiat currency value, transferring from the financial management system to the employee the difference between the settling amount and the original fiat currency value.
